(19) United States
(12) Patent Application Publication
(10) Pub. No.: US 2019/0394513 A1
(43) Pub. Date: Dec. 26, 2019

(54) AUTONOMOUS DRIVING SYSTEM AND MEDIA PLAYBACK METHOD THEREOF

(71) Applicant: LG ELECTRONICS INC., Seoul (KR)

(72) Inventors: Sangmi SHIN, Seoul (KR); Seongmin KIM, Seoul (KR); Jin SEO, Seoul (KR)

(21) Appl. No.: 16/553,809

(22) Filed: Aug. 28, 2019

(30) Foreign Application Priority Data
Jul. 26, 2019 (KR) 10-2019-0091057

(51) Int. Cl. H04N 21/414; H04N 21/442; H04N 21/44; H04N 21/458; H04N 21/437; H04N 21/432; H04N 21/466

(52) U.S. Cl. CPC H04N 21/41422; H04N 21/44209; H04N 21/44004; H04N 21/4667; H04N 21/437; H04N 21/4325; H04N 21/458

(57) ABSTRACT

An autonomous driving system includes: an alternative content collector that creates an alternative content pool by collecting alternative contents; a network sensitivity predictor that predicts a communication instability section on a route of a vehicle that is being driven; a media player that plays a current content in the vehicle that is being driven and plays the alternative content when entering the predicted communication instability section or before entering the communication instability section; and a media controller that selects the current content and the alternative content from the alternative content pool and provides the current content and the alternative content to the media player. One or more of an autonomous vehicle, a user terminal and a server of the present disclosure may be associated with artificial intelligence modules, drones (unmanned aerial vehicles (UAVs)), robots, augmented reality (AR) devices, virtual reality (VR) devices, devices related to 5G service, etc.

### CROSS-REFERENCE TO RELATED APPLICATION

This application claims the benefit of Korean Patent Application No. 10-2019-0091057 filed on Jul. 26, 2019, the entire contents of which is incorporated herein by reference for all purposes as if fully set forth herein.

### BACKGROUND

### Field of the Disclosure

The present disclosure relates to a media playback method of an autonomous driving system and, more particular, autonomous driving system that automatically plays alternative contents when a media playback quality is deteriorated or communication with a network is unstable, and a media playback method thereof.

### Description of the Background

Vehicles, in accordance with the prime mover that is used, can be classified into an internal combustion engine vehicle, an external combustion engine vehicle, a gas turbine vehicle, an electric vehicle or the like.

An autonomous vehicle refers to a vehicle that can be driven by itself without operation by a driver or a passenger and an autonomous driving system refers to a system that monitors and controls such an autonomous vehicle so that the autonomous vehicle can be driven by itself.

### SUMMARY

In the age of connected cars and autonomous vehicles, since intervention of a driver in the vehicles is minimized, so consumption of media in the vehicles is increased. Accordingly, a media playback method considering various driving environments is required.

As examples of a media playback method while a vehicle is driven, there are video/audio streaming, radio broadcast reception, internet radio reception, etc. When a signal received from a network while a vehicle is driven is weak, for example, media playback quality may be deteriorated such as noise increases during media playback and playback is stopped when the vehicle passes through a tunnel section.

An object of the present disclosure is to solve the necessities and/or problems described above.

Another object of the present disclosure is to provide an autonomous driving system that reduces inconvenience of users in a vehicle due to deterioration of media playback quality even though the media playback quality is deteriorated while the vehicle is driven, or the vehicle passes through a communication instability section.

The autonomous driving system according to an embodiment of the present disclosure includes: an alternative content collector that creates an alternative content pool by collecting alternative contents; a network sensitivity predictor that predicts a communication instability section on a route of a vehicle that is being driven; a media player that plays a current content in the vehicle that is being driven and plays the alternative content when entering the predicted communication instability section or before entering the communication instability section; and a media controller that selects the current content and the alternative content from the alternative content pool and provides the current content and the alternative content to the media player.

The alternative content is selected from the alternative content pool before a vehicle enters the predicted communication instability section. The alternative content is selected on the basis of a result of learning user's interest and preference.

The media playback method includes: storing an alternative content pool into a media buffer of the vehicle by collecting alternative contents; playing a current content in a vehicle that is being driven; determining a pre-predicted communication instability section on a route of the vehicle that is being driven; and playing an alternative content selected from the alternative content pool when entering the predicted communication instability section or before entering the predicted communication instability section.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram illustrating the interior of a vehicle according to an embodiment of the present disclosure.

FIG. 10 is a block diagram referred to in description of a cabin system for a vehicle according to an embodiment of the present disclosure.

FIG. 11 is a diagram referred to in description of a usage scenario of a user according to an embodiment of the present disclosure.

FIG. 12 is a diagram showing an example of a method of converting into contents when playback quality of contents is deteriorated or a stop occurs.

FIG. 13 is a flowchart briefly showing a media playback method according to an embodiment of the present disclosure.

FIG. 14 is a diagram showing an example of predicting a communication instability section through communication with surrounding vehicles before entering a tunnel section.

FIG. 15 is a flowchart showing in detail a media playback method according to an embodiment of the present disclosure.

FIG. 16 is a flowchart showing in detail a media playback method according to another embodiment of the present disclosure.

FIG. 17 is a block diagram showing a media playback system of an autonomous driving system according to an embodiment of the present disclosure.

FIG. 18 is a diagram showing a signal sequence among components of a media playback system.

FIG. 19 is a flowchart showing in detail a media playback method according to another embodiment of the present disclosure.

FIGS. 20A and 20B are a flowchart showing in detail a media playback method according to another embodiment of the present disclosure.

FIGS. 21A to 25 are diagrams showing an example of UX (User Experience) images of a media playback method according to an embodiment of the present disclosure.

### DETAILED DESCRIPTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereafter, a device that requires autonomous driving information and/or 5G communication (5th generation mobile communication) that an autonomous vehicle requires are described through a paragraph A to a paragraph G

A. Example of Block Diagram of UE and 5G Network

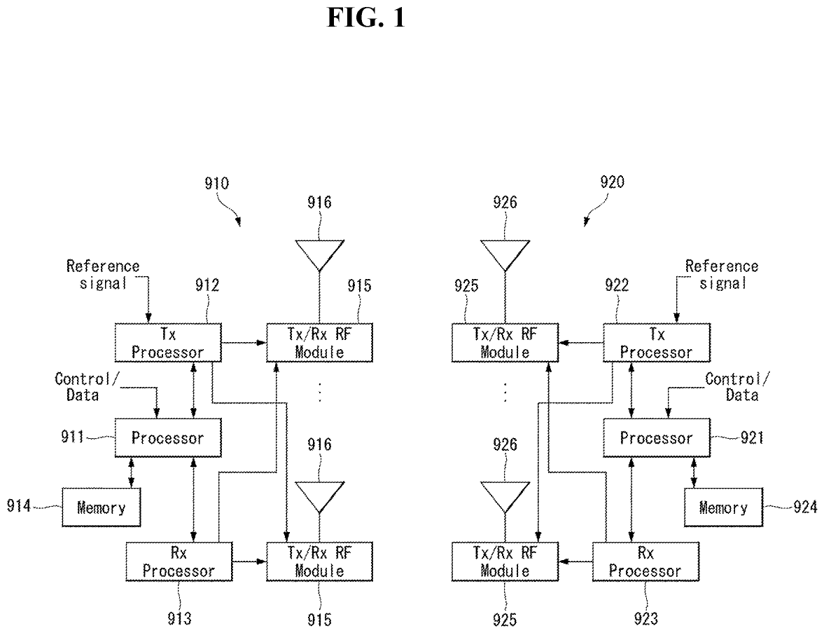

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

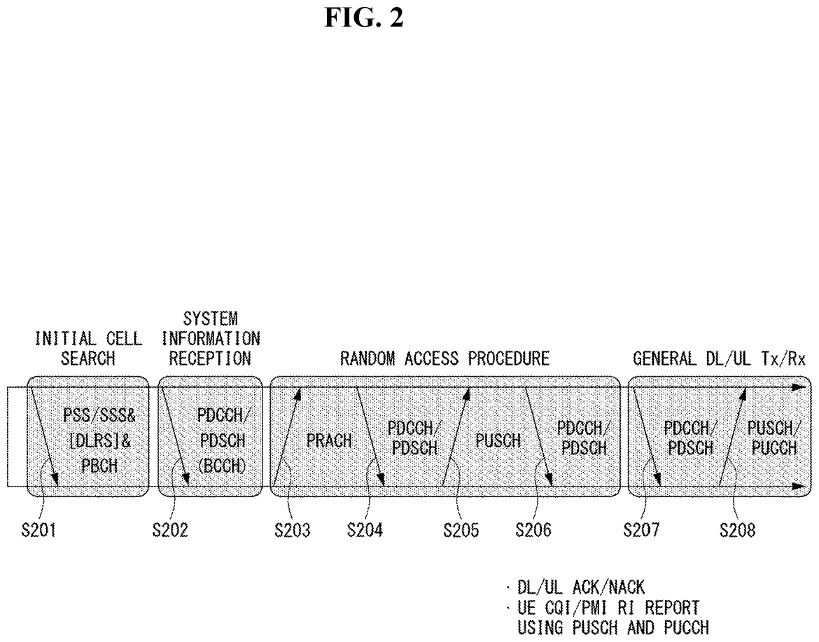

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

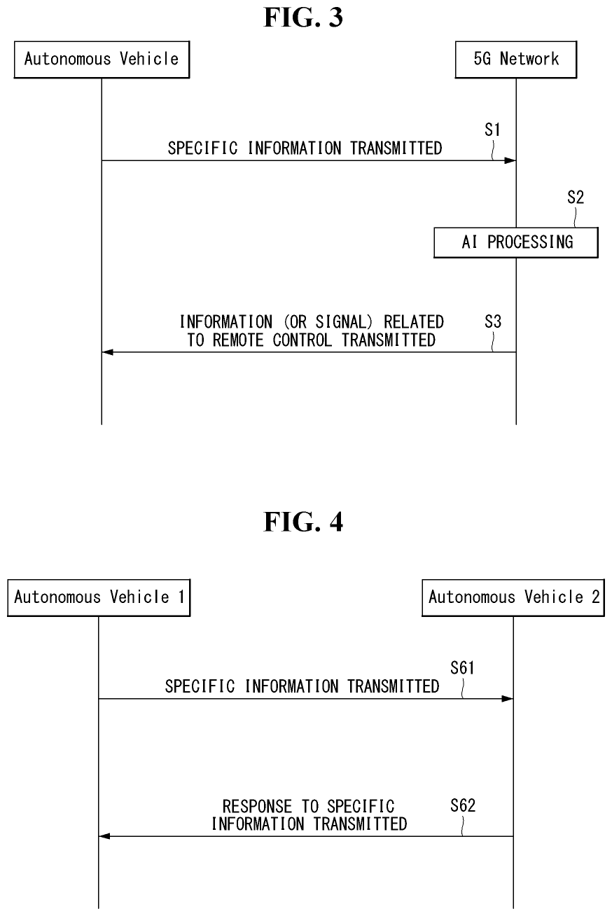

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

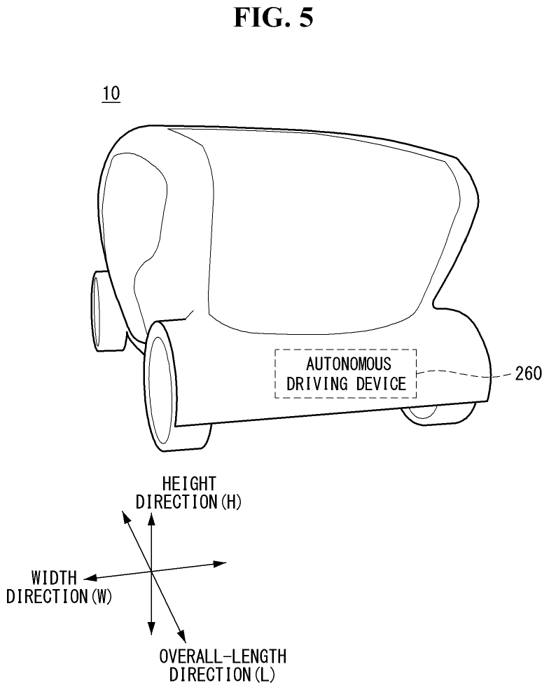

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

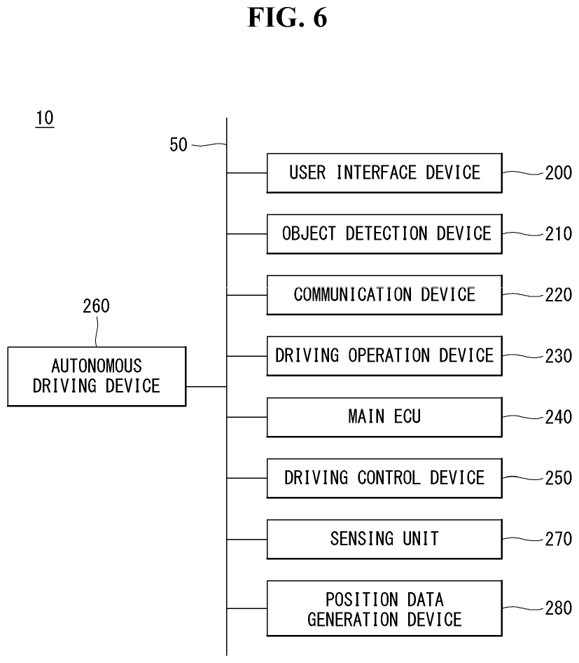

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous driving device 260, a sensing unit 270, and a position data generation device 280. The object detection device 210, the communication device 220, the driving operation device 230, the main ECU 240, the driving control device 250, the autonomous driving device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images.

The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous driving device 260. For example, the driving control device 250 can control a power train, a steering device and a brake device on the basis of signals received by the autonomous driving device 260.

7) Autonomous Device

The autonomous driving device 260 can generate a route for self-driving on the basis of acquired data. The autonomous driving device 260 can generate a driving plan for traveling along the generated route. The autonomous driving device 260 can generate a signal for controlling movement of the vehicle according to the driving plan. The autonomous driving device 260 can provide the signal to the driving control device 250.

The autonomous driving device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous driving device 260 can perform switching from a self-driving mode to a manual driving mode or switching from the manual driving mode to the self-driving mode. For example, the autonomous driving device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

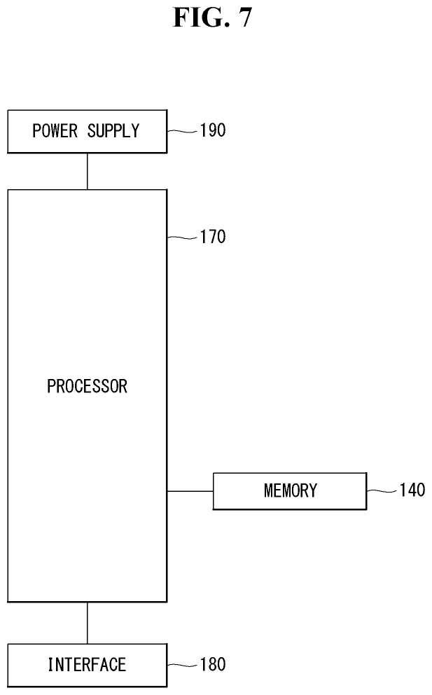

FIG. 7 is a control block diagram of the autonomous device according to an embodiment of the present disclosure.

Referring to FIG. 7, the autonomous driving device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous driving device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous driving device 260. The power supply 190 can be provided with power from a power source (e.g., a battery) included in the vehicle 10 and supply the power to each unit of the autonomous driving device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous driving device 260 may include at least one printed circuit board (PCB). The memory 140, the interface 180, the power supply 190 and the processor 170 may be electrically connected to the PCB.

(4) Operation of Autonomous Device

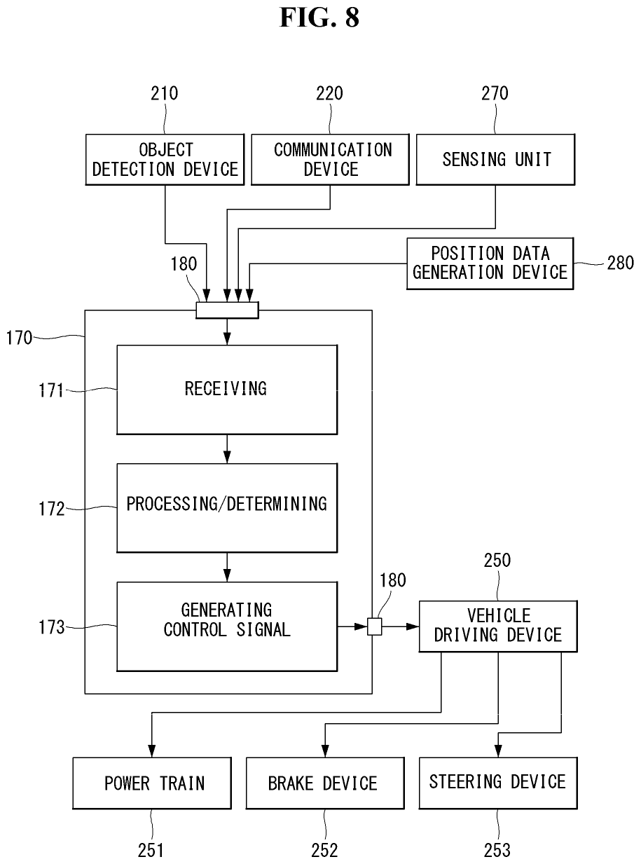

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

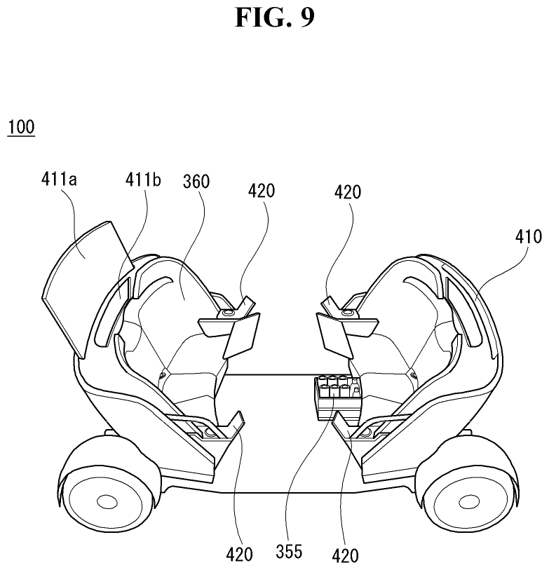

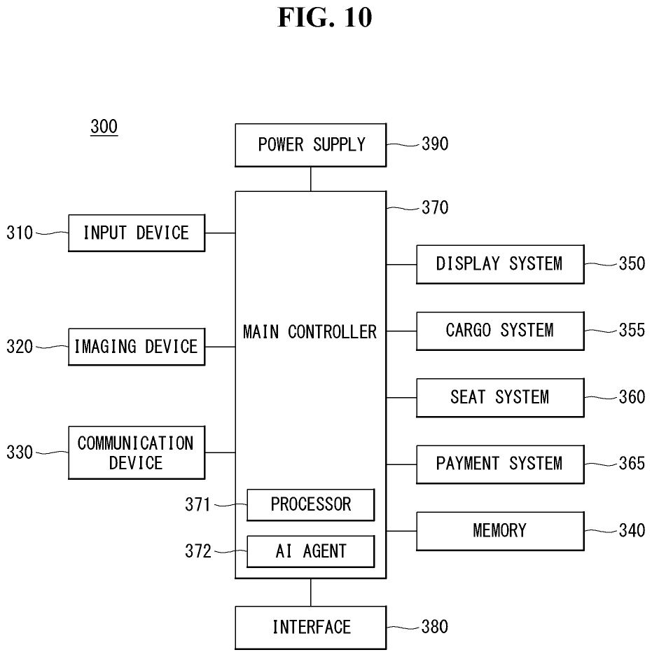

FIG. 9 is a diagram showing the interior of the vehicle according to an embodiment of the present disclosure. FIG. 10 is a block diagram referred to in description of a cabin system for a vehicle according to an embodiment of the present disclosure.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

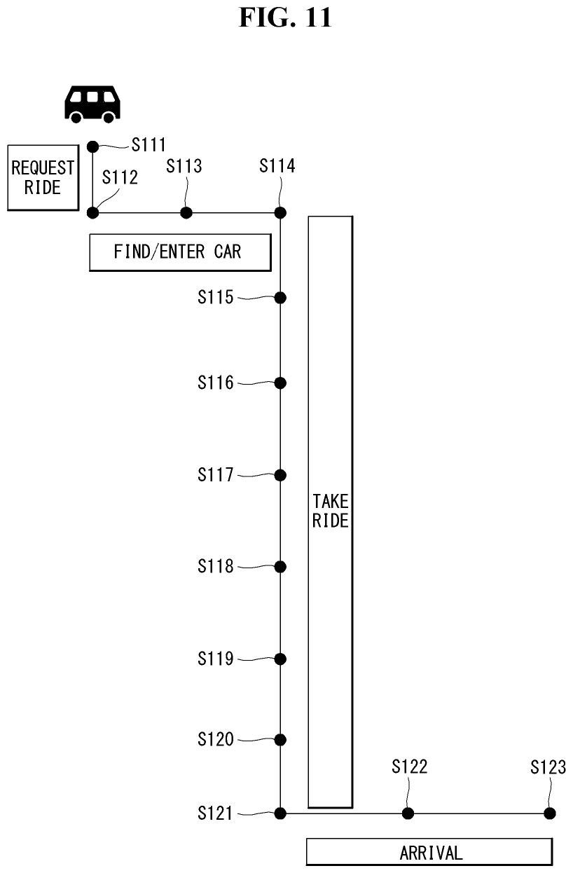

FIG. 11 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users.

The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present disclosure which will be described later and applied or can complement the methods proposed in the present disclosure to make technical features of the present disclosure concrete and clear.

Hereinafter, various embodiments of the present disclosure will be described in detail with reference to the attached drawings.

A vehicle of the present disclosure may include an IVI (In-Vehicle Infotainment) system. The IVI system can provide audio/video contents and various items of information to a user in connection with the display system 350, the communication system 330, a media player (or video/audio player), etc. Hereafter, a user may be construed as a passenger in a vehicle.

Hereafter, an autonomous driving system and a media playback method thereof according to an embodiment of the present disclosure are described in detail.

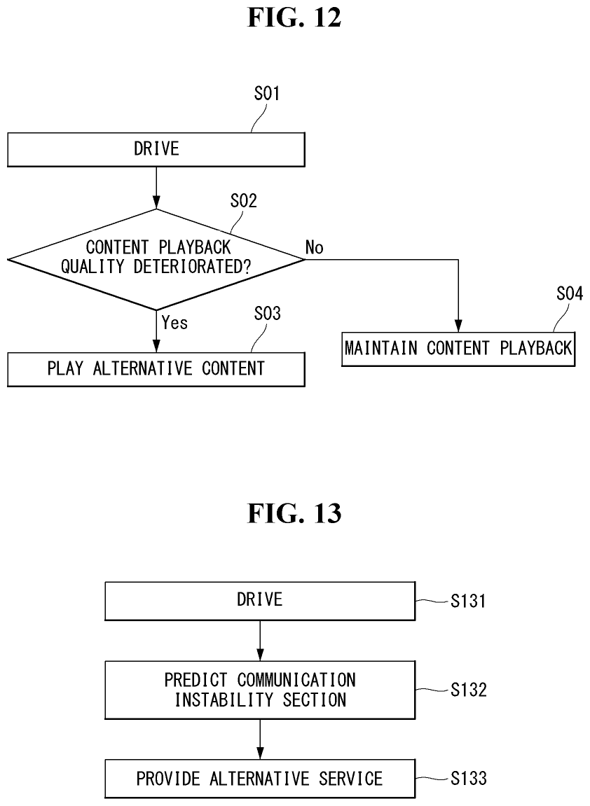

The present disclosure, as shown in FIG. 12, can sense deterioration of playback quality of video/audio contents that are played through a media play of a vehicle or a playback stop (S02) while the vehicle is driven. Here, the video/audio contents may be any one of contents that are received as real-time streaming data through a network, contents that are received as radio broadcast signals, and contents stored in a media buffer (or memory) of a vehicle.

The present disclosure can provide an alternative content pool by learning contents that a user prefers on the basis of user's playback history and collecting and storing alternative contents in a media buffer of a vehicle on the basis of the learned result. The present disclosure can read alternative contents from a media buffer and play them through a media player of a vehicle when playback quality of video/audio contents is deteriorated or a stop occurs while the vehicle is driven (S03). When contents playback quality is not deteriorated under a predetermined level and there is no contents playback stop, the current content playback is maintained (S04).

When deterioration of playback quality of video/audio contents or a stop is sensed and an alternative content is played, a user has to watch noise when converting into the alternative content.

The present disclosure predict in advance a media communication environment (internet, RF) of a route using information obtained through one of route information and communication with a surrounding vehicle. The route information may include map data, traffic situation data on the route, navigation data, etc.

The present disclosure implements alternative contents in a media buffer of a vehicle by collecting customer-fit alternative contents on the basis of a learning result abut user's interest (or preference) in preparation for a case when a communication signal is unstable. Accordingly, an autonomous driving system can enable a user to keep watching contents or can provide alternative contents even if a real-time streaming data signal that is received through a network is weakened or disconnected in a driving environment in which the quality of signals received from the network is deteriorated.

A media playback method of the present disclosure, as shown in FIG. 13, predicts a communication instability section predicted on the basis of route information or a surrounding vehicle (S132) while a vehicle is driven (S131) The media playback method of the present disclosure automatically starts to play an alternative content selected from the alternative content pool prepared in advance when entering a predicted communication instability section or when entering a predicted communication instability section. The alternative content may be selected from the alternative content pool before a vehicle enters a predicted communication instability section. Accordingly, the media playback method of the present disclosure can convert contents without noise exposure in a process of converting into alternative contents.

The media playback method of the present disclosure can predict in advance communication instability sections such as a tunnel, a mountain region, and island areas through a route. A predicted communication instability section may be determined as a route mapped on a map. Further, the media playback method of the present disclosure can predict a communication instability section that a vehicle is to enter within a predetermined time, for example, several seconds on the basis of data received through a surrounding vehicle or a network through V2X while the vehicle is driven.

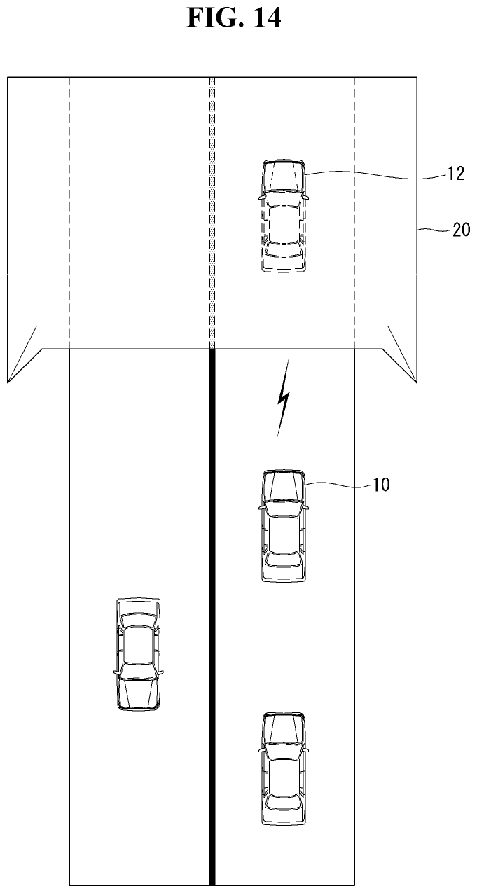

There may be an unknown communication instability section on a route. In this case, the autonomous driving system can determine a communication instability section through V2V communication with another vehicle 12 being driven forward, as shown in FIG. 14. A section in which communication signal intensity with the another vehicle 120 may be determined as a communication instability section. The example of FIG. 14 shows a situation in which the vehicle 10 predicts a communication instability section on the basis of a signal received through V2V (Vehicle to Vehicle) communication with the another vehicle 12 being driven forward.

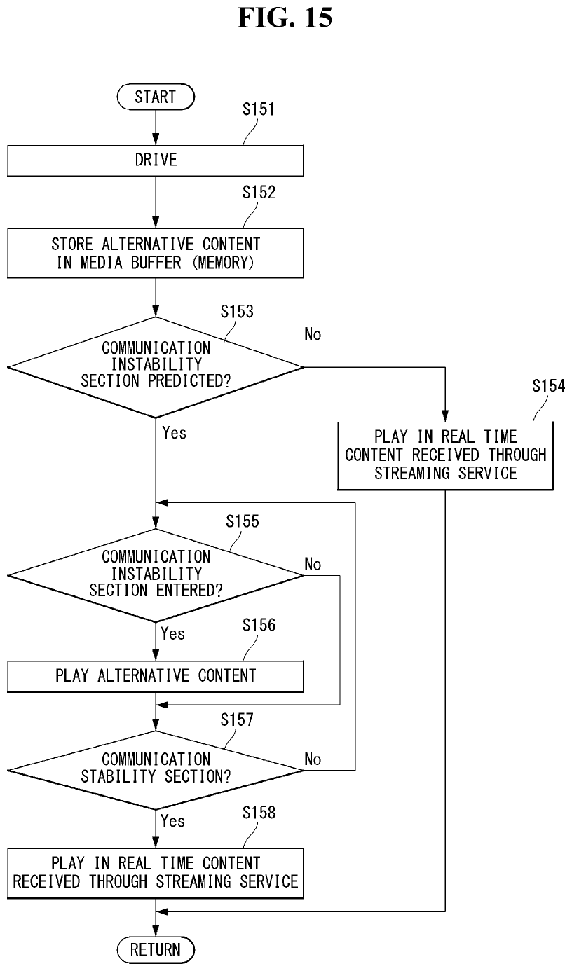

FIG. 15 is a flowchart showing in detail a media playback method according to an embodiment of the present disclosure.

Referring to FIG. 15, the media playback method collects alternative contents and stores an alternative content pool in a media buffer (memory) while a vehicle is driven (S151 and S152). The media buffer may be construed as a local storage.

The media playback method can predict a communication instability section on the basis of a route and the signal intensity of data of a signal received from another vehicle being driven forward or a network (S153). The communication instability section plays an alternative content selected from the alternative content pool prepared in advance when or before a vehicle being driven enters a communication instability section (S155 and S156). In a section without a communication instability section, the vehicle maintains the current content playback without converting into an alternative content. The current content may be a video/audio content that is received in real time through a streaming service.

The media playback method can start again to play a content that is received through a streaming service when the vehicle that is being driven passes the end of the communication instability section (S158). Alternatively, the content that has been played before the alternative content is played may be played again.

The alternative contents may include various types of alternative contents such as a video/audio content, traffic information, weather, an email, an advertisement, and news. The advertisement may include one or more of a banner advertisement, a voice advertisement, and a video advertisement. The alternative contents may further include a podcast, radio broadcast contents, etc. The alternative contents may be selected or added as the result of learning that considers user's interests on the basis of a content playback history, an application execution history, etc. by a user. The alternative contents may be selected in consideration of the context in a vehicle that is being driven.

The medial playback method can collect and schedule alternative contents in the following method. The alternative contents may be selected on the basis of user's long-term interests or profile and short-term interests or context information indicating the situation in a vehicle, and can be collected as contents suitable for user's interests and the situation in the vehicle. The long-term interests reflect user's interests learned on the basis of a user's content playback history and an application history accumulated from before the user gets in a vehicle that is being driven. The short-term interests reflect the recent interest of contents that a user in a vehicle that is being driven now has watched. The context information reflects the situation of the vehicle that is being driven now. For example, when a user in a vehicle that is being driven is asleep, an alternative content can be selected in consideration of the sleeping user, and the playback volume and screen brightness can be adjusted into a sleeping mode.

The scheduling defines the playback order of alternative contents on the basis of a predetermined algorithm in consideration of the user's long-term interests or profile, short-term interests or context information, and the situation in the vehicle.

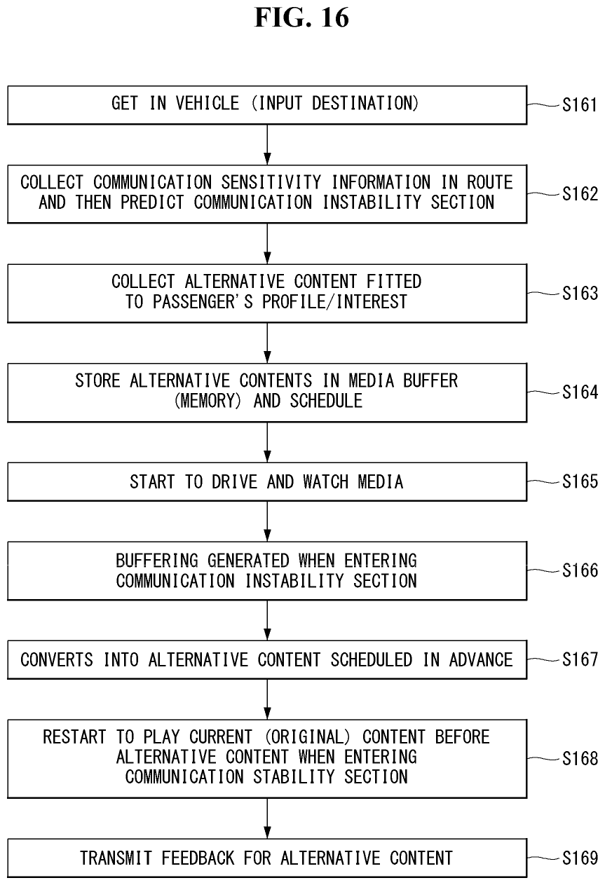

FIG. 16 is a flowchart showing in detail a media playback method according to another embodiment of the present disclosure.

Referring to FIG. 16, a user gets in a vehicle and inputs a destination (S161).

The autonomous driving system collects communication sensitivity information in a route and predicts communication instability sections (S162). The route may be construed as a distance section analyzed on the basis of the horizon described above.

The autonomous driving system collects alternative contents on the basis of the user's profile or a learning result of interests while the vehicle is driven (S163). The autonomous driving system prepares an alternative content pool by storing alternative contents in a media buffer (memory) and defines a playback priority order of contents through scheduling (S164).

The autonomous driving system creates a route to the destination and a driving plan and starts to drive. The autonomous driving system can play a current content selected by the user in accordance with a media watching request (S165).

The autonomous driving system can perform media buffering on contents received through a real-time streaming service when or before the vehicle enters a predicted communication instability section (S166). The autonomous driving system selects an alternative content stored in the media buffer when or before entering the communication instability section and converts the current content into the alternative content and plays the alternative content before the vehicle enters the communication instability section (S167).

While the alternative content is consumed, when the vehicle comes out of the communication instability section and enters a communication stability section, the autonomous driving system returns to the current content and plays the current content before the alternative content (S168). The current content that is played when the vehicle enters the communication stability section may be data of a buffered content.

The autonomous driving system can store feedback data for the alternative content or transmit the feedback data to an external device (or a server) through a network (S169). The feedback data are used to record user's reaction or action in a log file when the alternative content is played. The log file is stored in the autonomous driving system or is transmitted to a network, whereby it can be used to select and collect the next alternative content.

For example, the autonomous driving system can exclude another content from the alternative content pool in accordance with user's reaction that the user converts halfway the content that is played in the communication stability section into the another content on the basis of the feedback data. Further, the autonomous driving system can exclude another content from the alternative content pool in response to user's reaction that the user converts halfway the content that is played in the communication stability section into the another content or turns down the volume on the basis of the feedback data.

The autonomous driving system can set a high priority for an audio content that is being played and of which the volume is turned up by the user or a content that is repeatedly played in the communication stability section in the alternative content pool in response to the feedback data.

The autonomous driving system can change the type of alternative contents or select the genre of audio/video contents on the basis of feedback data indicating user's reaction.

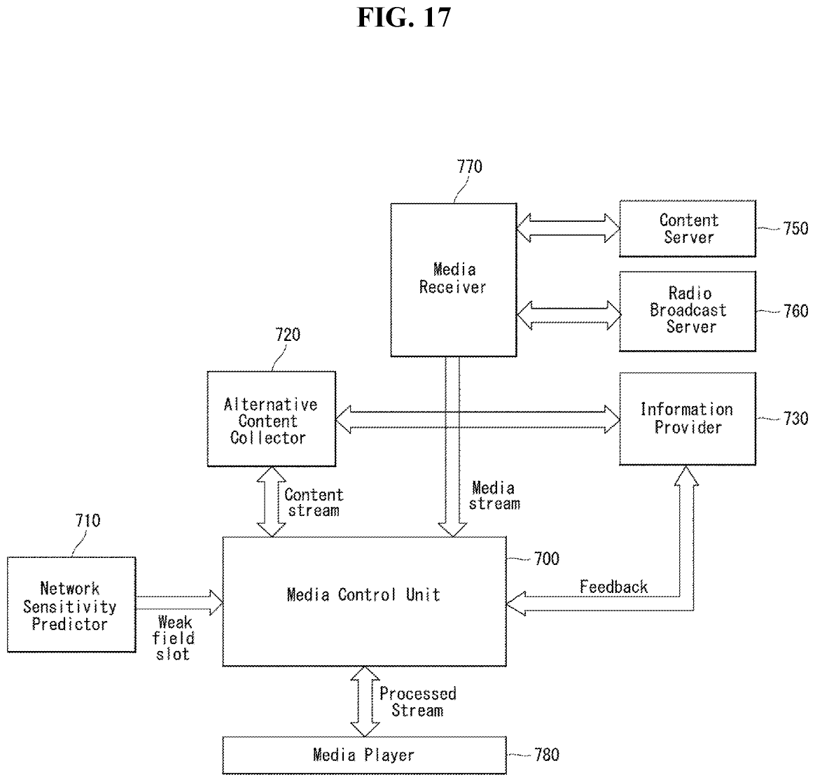

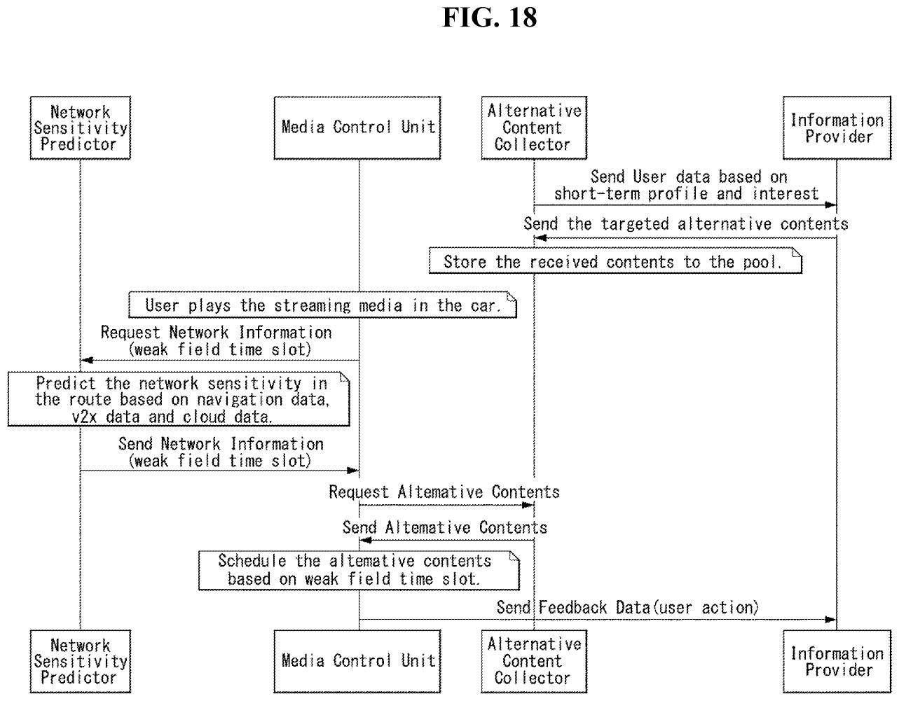

The autonomous driving system of the present disclosure includes a media playback system shown in FIGS. 17 and 18. The media playback system includes a network sensitivity predictor 710, a medal control unit 700, an alternative content collector 720, and an information provider 730. The network sensitivity predictor 710, the medal control unit 700, the alternative content collector 720, and the information provider 730 are linked with an IVI system and can share a hardware resource.

FIG. 17 is a block diagram showing a media playback system of an autonomous driving system according to an embodiment of the present disclosure. FIG. 18 is a diagram showing a signal sequence among components of a media playback system.

Referring to FIG. 17, the autonomous driving system may include a network sensitivity predictor 710, a medal control unit 700, an alternative content collector 720, and an information provider 730.

The autonomous driving system may further include a content server 750, a radio broadcast server 760, a media receiver 770, and a media player 780.

The network sensitivity predictor 710 predicts a communication instability section by synthesizing the length of a section where a communication signal is weakly received such as a tunnel second, a mountain region, and island areas on a route, and a traffic situation. Further, the network sensitivity predictor 710 can predict a communication instability section by collecting information about the intensity of a signal received from another vehicle being driven forward on the route and the intensity of a signal received from a network. The network sensitivity predictor 710 can provide a weak field time slot that defines a communication instability section where received signal intensity is weak to the medial control unit 700.

The alternative content collector 720 collects one or more alternative contents, which are suitable for user's long-term interests or profile, from the information provider 730 when the user gets in a vehicle. The alternative content collector 720 makes and stores an alternative content pool in a memory. The alternative content collector 720 can update an alternative content to be played in a communication instability section to the alternative content pool when entering a predicted communication instability section or before entering a communication instability section. The alternative content collector 720 transmits user's short-term interests and context information indicating the situation in the vehicle to the information provider 730 and receives an alternative content suitable for the short-term interests and the situation in the vehicle from the information provider 730 in a communication stability section on the route, thereby being able to update the alternative content pool. The alternative content collector 720 transmits an alternative content (content stream) to the medial control unit 700.

When all the alternative contents stored in the alternative content pool are exhausted, the alternative content collector 720 can update and store alternative contents in a media buffer in a communication stability section. The alternative content collector 720 can maintain the existing alternative content pool in a communication instability section.

Even if the reception intensity of a broadcast signal is weak in a communication instability section, the signal intensity of V2X communication may be good. In this case, the alternative content collector 720 can share a content received from another vehicle through V2X communication and can transmit the content as an alternative content to the media control unit 700.

The alternative content collector 720 can update the alternative content pool stored in the media buffer in a communication stability section and can maintain the alternative content pool stored in the media buffer in a communication instability section. The alternative content collector 720 can select or add alternative contents on the basis of user's preference and interests learned on the basis of a content playback history and an application execution history of the user.

The alternative content collector 700 can update the alternative content pool stored in the media buffer in a communication stability section. The alternative content collector 700 can maintain the alternative content pool stored in the media buffer in a communication instability section.

The alternative content collector 720 can collect an alternative content suitable for an information long-term interest or profile from the information provider 730 when a user gets in the vehicle. The alternative content collector 720 can update the alternative content pool with an alternative content suitable for a user's short-term content or the situation in the vehicle from the information provider 730 in a communication stability section.

The media control unit 700 includes an engine and a feedback manager. The engine schedules an alternative content to be played in a predicted communication instability section. The engine can perform scheduling using a predetermined algorithm in consideration of user's long-term interests or profile, short-term interests or context information, and the situation in the vehicle provided from the information provider 3730.

The engine is provided with an alternative content (content stream) from the alternative content collector and is provided with contents (media stream) from the media receiver 770. The engine provides the data of the current content received from the media receiver 770 to the medial player 780 in a communication stability section. The engine can provide alternative contents to the media player 780 in the scheduled order in a communication instability section.

The feedback manager makes a log file by logging user' reaction or action to an alternative content that is consumed in a communication instability section, and stores the log file in the media buffer or a separate memory. The feedback manager transmits feedback information about the alternative content consumed in the communication instability section to the information provider 730.

The media receiver 770 receives a content requested by the media control unit 700 from the content server 750 and provides the content to the media control unit 700. Further, the media receiver 770 receives a radio broadcast signal requested by the media control unit 700 from the radio broadcast server 760 and provides the radio broadcast signal to the media control unit 700.

The media player 780 plays the current content and the alternative content received from the media control unit 700. The media player 780 includes a media buffer in which content data are stored, and performs media buffering.

The media player 780 can play contents from another vehicle received from the media control unit 700 in a communication instability section.

Referring to FIG. 18, the alternative content collector 720 transmits user data including short-time profile and interests to the information provider 730. The information provider 730 provides alternative contents suitable for the short-time profile and interests to the alternative content collector 720.

The alternative content collector 720 can create an alternative content pool or update an alternative content pool by storing alternative content data received from the information provider 730 into a memory.

The media control unit 700 can play a content on the media player 780 on the basis of user's input in the vehicle that is being driven. The media control unit 700 requests communication instability section information (weak field time slot) from the network sensitivity predictor 710.

The network sensitivity predictor 710 determines a weak electric field section on the basis of the intensity of landmarks on route information, a V2X signal (V2X data), or a network signal (cloud data), predicts a communication instability section, and provides communication instability section information (weak field time slot) to the medial control unit 700.

The media control unit 700 requests an alternative content from the alternative content collector in response to communication instability section information (weak field time slot) predicted from the network sensitivity predictor 710. The alternative content collector 720 provides an alternative content in response to the request of the media control unit 700.

The media control unit 700 schedules contents to be played in a predicted communication instability section. The media control unit 700 can perform scheduling in consideration of user's long-term interests or profile, short-term interests or context information, and the situation in the vehicle.

The media control unit 700 provides feedback data for an alternative content played in a communication instability section tot eh information provider 730. The information provider 730 may be provided to an artificial intelligence agent (372 in FIG. 10) to learn the degrees of user's interest and preference about alternative contents.

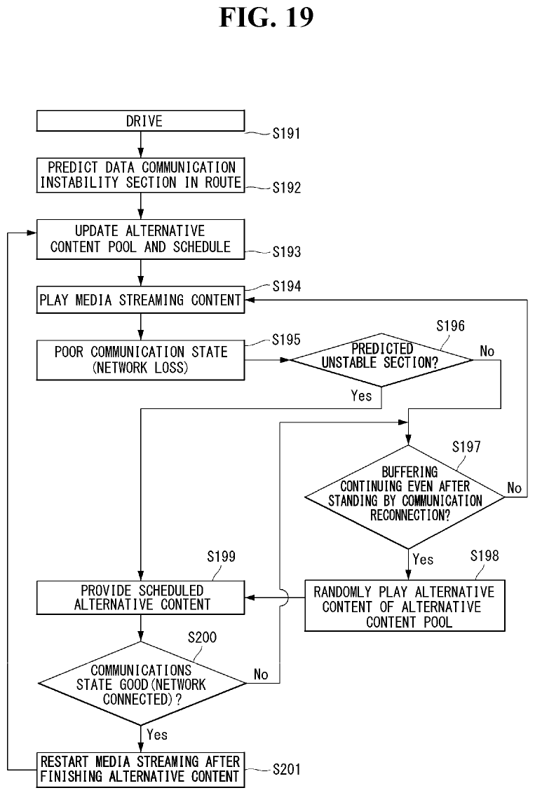

FIG. 19 is a flowchart showing in detail a media playback method according to another embodiment of the present disclosure.

Referring to FIG. 19, the media playback method of the present disclosure can predict a data communication instability section on a route of a vehicle in connection with a V2X communication network and communication company cloud server.

The media playback method can update an alternative content pool and perform scheduling when or before a vehicle enters a predicted communication instability section (S193). The medial control unit 700 can receive user's long-term and short-term interest information and context information from the information provider 730 and can schedule alternative contents on the basis of the information.

The media player 780 can play media streaming contents provided through a streaming service while the vehicle is driven (S194).

The media control unit 700 determines whether it is a predicted communication instability section when a communications state is not good or the contents of the media buffer is exhausted at the current location of the vehicle that is being driven on the basis of information provided from the network sensitivity predictor 710 (S195 and S196). The media control unit 700 determines whether the section where communication state is not good (poor communication state section) is a predicted communication instability section (S196). The media control unit 700 provides scheduled alternative contents to the media player 780 when the current poor communication state section is a predicted communication instability section (S199). Accordingly, the media player 780 plays alternative contents in the communication instability section.

The media control unit 700 can play alternative contents when the contents of the media buffer are exhausted and while buffering is continued. The media control unit 700 can set a priority order on the basis of feedback information about the alternative contents consumed in the communication instability section and can control the playback order of alternative contents to be played in the communication instability section in accordance with the priority order. In this case, the media player 780 can be controlled by the media control unit 700 to sequentially play alternative contents in accordance with the priority order in the communication instability section.

The media control unit 700 can set first or randomly defects of alternative contents to be played for a time for which the vehicle is driven in a communication instability section or a time for which a communication instability section continues in accordance with a traffic situation. Further, it may be possible to predict a communication instability section continuity time of a driving vehicle and select alternative contents in consideration of the predicted time. For example, when a time for which a vehicle is stagnated in a communication instability section is inferred as 1 minutes, a content that can be fully played for 1 minutes or a time closest to 1 minutes can be selected as an alternative content.

The media control unit 700 can set a high priority for an audio content that is being played and of which the volume is turned up by the user or a content that is repeatedly played in the communication stability section in the alternative content pool in response to the feedback data.

The media control unit 700 can change the type of alternative contents or select the genre of audio/video contents on the basis of feedback data. For example, when a user frequently watches news, it is possible to select an alternative content type as news. Further, when a user prefers lock music, the autonomous driving system can select a high priority order in preference for lock music as an alternative content.

When the current poor communication state section is not a predicted communication instability section, the media control unit 700 controls the autonomous driving system in a communication reconnection standby mode. When media buffering continues for a predetermined time in the communication reconnection standby mode, the media control unit 700 randomly select an alternative content of the alternative content pool and transmits the alternative content to the media player 780 (S197 and S198). Accordingly, the media player 780 can play an alternative content in a poor communication state section that is not a predicted communication instability section.

When media buffering stops within a predetermined time in the current poor communication state section, the media control unit 700 returns to step S194 and can generate an instruction code that instructs media streaming content playback.

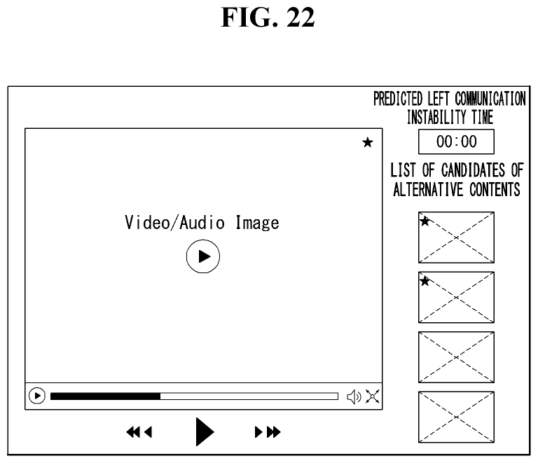

FIGS. 22 to 25 are diagrams showing an example of UX (User Experience) images of a media playback method according to an embodiment of the present disclosure.

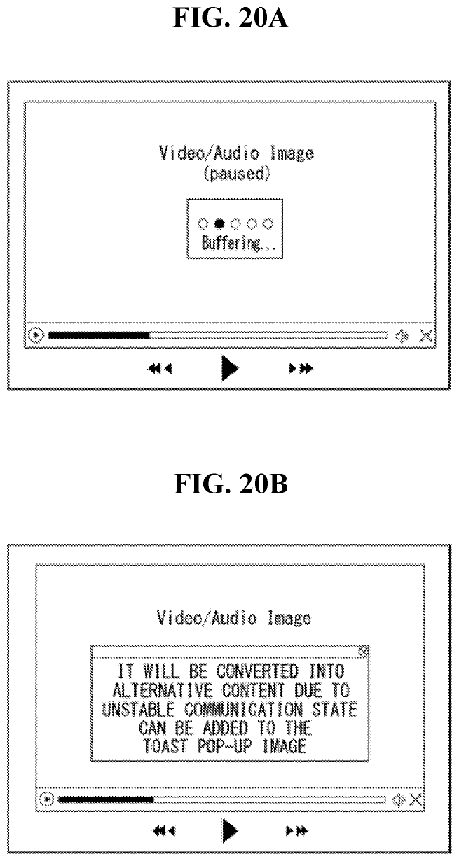

When a communication state is unstable, buffering occurs during media playback, and buffering time continues for a predetermined time, the UX image, as shown in FIG. 20A, can be provided. Here, the predetermined time may be several seconds, for example, 5 seconds. After the predetermined time passes, a toast pop-up image, as shown in FIG. 20B, can be displayed on a display. An alternative content conversion guide message such as “It will be converted into alternative content due to unstable communication state” can be added to the toast pop-up image. This UX image can be displayed without user's input and can be automatically converted into an alternative content after the toast pop-up image.

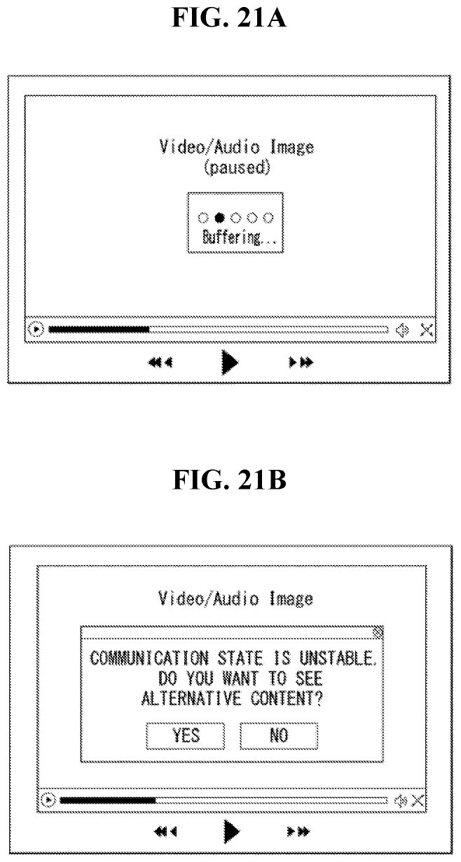

When a communication state is unstable, buffering occurs during media playback, and buffering time continues for a predetermined time, the UX image, as shown in FIG. 21A is provided, and then a selection pop-up image, as shown in FIG. 21B can be displayed on the display. In order to prevent image noise or noise that may be unpleasant is not transmitted to a user in media buffering, the image may be replaced with a pause image (buffering image) or a predetermined loading sound in advance. A guide message that requests user's selection such as “Media cannot be played due to unstable communication state. Do you want to convert into alternative content?, Yes/No” may be added to the selection pop-up image. The image can be converted into an alternative content in accordance with user's input.

A voice guidance may be output through a speaker when it is converted into an alternative content.

A voice guide message can be played in a communication instability section, when noise/buffering is generated while radio/podcast are played, and when noise/buffering continues for a predetermined time or more. For example, a message “It will be converted into alternative content due to unstable communication state” may be output through a sound. When a radio signal is weak, a predetermined buffering signal sound may be played in advance in preparation for noise or a case when an audio streaming is severely disconnected. It may be possible to automatically convert into an alternative content regardless of user's input after the voice guidance is output.

It is possible to convert into an alternative content in response to user's selection after a voice guide message is played. In this case, as an example of a voice guide message, “Communication state is unstable. Press 00 Key if you want to convert into alternative content” may be added to the voice guide message.

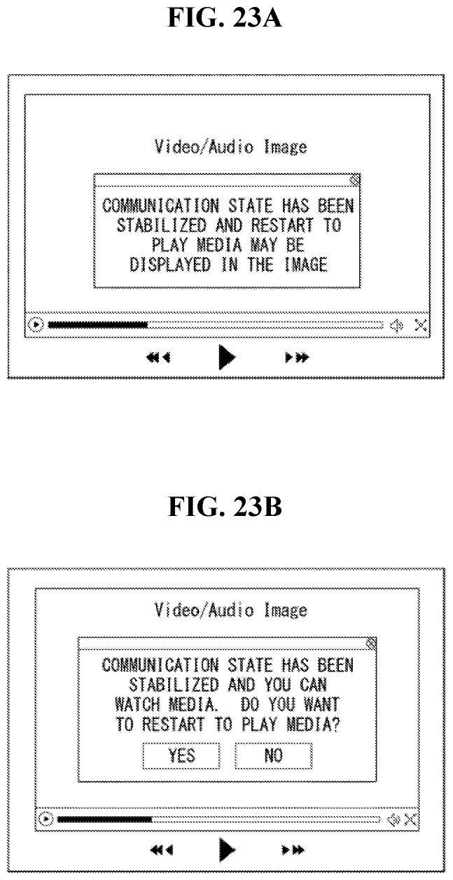

A UX image, as shown in FIGS. 23A and 23B, may be displayed on the display screen while an alternative content is played in a communication instability section.

Referring to FIG. 22, an image of an alternative content may be displayed in a region of interest (ROI) of a display screen, and the predicted left communication instability time and a list of candidates of alternative contents that will be played next in accordance with scheduling or are recommended may be displayed in the edge of the screen.

When the connection state of an internet network is good and RF broadcast signal reception is good while an alternative content is played, media can be normally played. When the internet network connection state is good but the RF broadcast signal reception state is not good, it is possible to play alternative content information that a user has a lot of interest in through voice output or a display when the user listens to the radio through an RF broadcast signal.

When the internet network connection state is good but the RF broadcast signal reception state is not good, a user can convert into listening of the radio. In this case, the autonomous driving system can output a message “You can convert into the radio due to weak RF reception signal” through voice output or a display and then can provide a selection image that requests the user to input whether to return to playback of an alternative content or the current media.

When the internet network connection state is not good but the RF broadcast signal reception state is good, the media playback method can maintain the current state if the current viewer is listening to the radio through an RF broadcast signal. Further, when the internet network connection state is not good but the RF broadcast signal reception state is good, the media playback method can play the content having a high user's interest in from an alternative content pool. A radio channel having high user's preference may be included in an alternative content.

When the internet network connection state is not good and the RF broadcast signal reception state is also not good, the media playback method can recommend a content having highest user's interest and preference of the alternative content pool and then can play the content after user's input or automatically.

When the communication state is stabilized, the media playback method can display a toast pop-up, as shown in FIG. 23A, on the display screen, and can restart the current content stopped before an alternative content automatically without user's input. As an example of the toast pop-up message, “Communication state has been stabilized and restart to play media” may be displayed in the image.

When the communication state is stabilized, the media playback method can request user's selection by displaying a selection pop-up, as shown in FIG. 23B, on the display screen, and can restart an alternative content or the current content stopped before an alternative content in accordance with user's input. As an example of the selection pop-up message, “Communication state has been stabilized and you can watch media. Do you want to restart media? Yes/No” may be displayed in the image.

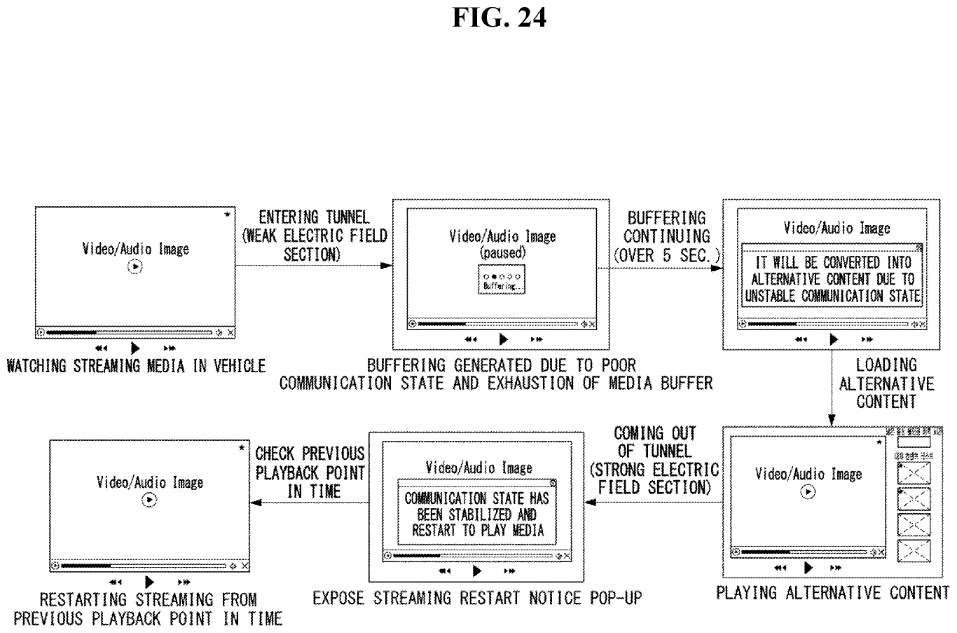

FIG. 24 is a diagram showing an example of a UX that is provided in a situation in which alternative contents have been scheduled in preparation for a stop of the current content that is being played in a predicted communication instability section.

Referring to FIG. 24, when a vehicle enters a weak electric field section while it is driven, media buffering is generated due to a poor communication state. When media buffering continues for a predetermined time or more, the media playback method can convert the playback media into an alternative content. The media playback method can automatically convert the playback media into an alternative content before buffering is generated when a media buffer is exhausted. When the vehicle comes out of a communication instability section such as a tunnel and enters a communication stability section, it is possible to display a streaming restart pop-up on the display screen and then restart to play the current content from the point in time of a stop before the alternative content.

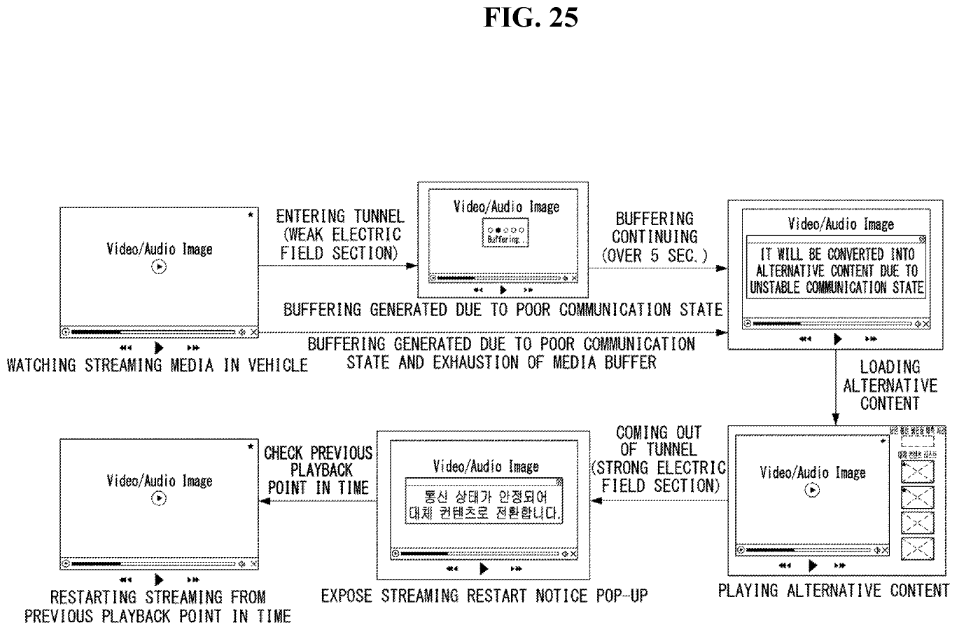

FIG. 25 is an example of UX images that are provided when a stop of media playback is not predicted.

While watching streaming media in an autonomous vehicle, a driver may face an unexpected stagnation situation due to traffic congestion in the tunnel. A communication state is poor and the stagnation time continues in the tunnel, so buffering may be generated for a long time during watching media and the medial buffer may go into an exhaustion state. In this case, the media playback method can predict a time until the communication state becomes good, using traffic situation information, a map, and V2V communication through a network, and can provide alternative contents stored in advance for the time. When the vehicle comes out of the tunnel and the communication state becomes good, the media playback method can restart the streaming media from the point in time of the previous playback.

Various embodiments of an autonomous driving system and a media playback method thereof of the present disclosure are briefly and simply described as follows.

Embodiment 1: The autonomous driving system according to an embodiment of the present disclosure includes: an alternative content collector that creates an alternative content pool by collecting alternative contents; a network sensitivity predictor that predicts a communication instability section on a route of a vehicle that is being driven; a media player that plays a current content in the vehicle that is being driven and plays the alternative content when entering the predicted communication instability section or before entering the communication instability section; and a media controller that selects the current content and the alternative content from the alternative content pool and provides the current content and the alternative content to the media player.

Embodiment 2: The network sensitivity predictor may predict the communication instability section on the basis of the route of the vehicle or may predict the communication instability section on the basis of intensity of a signal received from another vehicle being driven ahead of the vehicle or a network.

Embodiment 3: The alternative content collector may create the alternative content pool by selecting alternative contents suitable for user's long-term interests or profile.

Embodiment 4: The autonomous driving system may further include an information provider that provides the alternative content suitable for one or more of short-term interest information received from the alternative content collector and context information indicating a situation in the vehicle to the alternative content collector. The alternative content collector may update the alternative content pool with the alternative contents provided from the information provider.

Embodiment 5: The media control unit may schedule a playback order of the alternative contents.

Embodiment 6: The alternative content collector may select or add the alternative contents on the basis of user's preference and interests learned on the basis of a content playback history and an application execution history of the user.

Embodiment 7: The current content may be one of a video/audio content and a broadcast signal that are received in real time through a streaming service.

Embodiment 8: The media player may be controlled by the media control unit to restart to play the current content when the vehicle that is being driven comes out of the predicted communication instability section and enters a communication stability section.

Embodiment 8: The media control unit may provide feedback data including user's reaction or action information to the alternative content played in the predicted communication instability section to the information provider when entering the communication stability section.

Embodiment 9: The media control unit attempts communication reconnection by converting into a communication reconnection standby mode when a current poor communication state section is not the predicted communication instability section, and transmits alternative contents to the media player to play alternative contents in the alternative content pool randomly or sequentially in accordance with a priority order determined on the basis of learned user's preference and interests when media buffering continues for a predetermined time in the poor communication state section.

Embodiments of a media playback method of the autonomous vehicle are as follows.

Embodiment 1: The media playback method may include: storing an alternative content pool into a media buffer of the vehicle by collecting alternative contents; playing a current content in a vehicle that is being driven; determining a pre-predicted communication instability section on a route of the vehicle that is being driven; and playing an alternative content selected from the alternative content pool when entering the predicted communication instability section or before entering the predicted communication instability section.

Embodiment 2: The media playback method may further include predicting the communication instability section on the basis of the route of the vehicle or predicting the communication instability section on the basis of intensity of a signal received from another vehicle being driven ahead of the vehicle or a network.

Embodiment 3: The media playback method may include selecting and collecting the alternative contents on the basis of user's long-term interests or profile and short-term interests or context information indicating a situation in the vehicle.

Embodiment 4: The media playback method may further include scheduling a playback order of the alternative contents.

Embodiment 5: The media playback method may further include selecting or adding the alternative contents on the basis of user's preference and interests learned on the basis of a content playback history and an application execution history of the user.

Embodiment 6: The current content may be one of a video/audio content and a broadcast signal that are received in real time through a streaming service.

Embodiment 7: The media playback method may further include restarting to play the current content when the vehicle that is being driven comes out of the predicted communication instability section and enters a communication stability section.

Embodiment 8: The media playback method may further include storing feedback data including user's reaction or action information to the alternative content played in the predicted communication instability section, or transmitting the feedback data to a network when entering the communication stability section.

Embodiment 9: The media playback method may further include updating an alternative content pool stored in the media buffer in the communication stability section; and maintaining the alternative content pool stored in the media buffer in the predicted communication instability section.

Embodiment 10: The media playback method may further include playing a content received from the another vehicle as the alternative content in the predicted communication instability section.

Embodiment 11: The media playback method may further include collecting alternative contents suitable for long-term interests or profile when a user gets in the vehicle; and collecting alternative contents suitable for user's short-term interests or a situation in a vehicle in the communication stability section.

The present disclosure can be achieved by computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

The autonomous system and a medial playback method thereof of the present disclosure collect and store customer-fit alternative contents in a memory on the basis of a learning result about user's interests in preparation for a case when a communication signal is unstable. Accordingly, an autonomous driving system can enable a user to keep watching contents or can provide alternative contents even if a real-time streaming data signal that is received through a network is weakened or disconnected in a driving environment in which the quality of signals received from the network is deteriorated.

The medial playback method of the present disclosure can start to play an alternative content selected from an alternative content pool when or before entering a predicted communication instability section. Accordingly, the media playback method of the present disclosure can convert contents without noise exposure in a process of converting into alternative contents.

The effects of the present disclosure are not limited to the effects described above and other effects can be clearly understood by those skilled in the art from the following description.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An autonomous driving system comprising:
an alternative content collector that creates an alternative content pool by collecting alternative contents;
a network sensitivity predictor that predicts a communication instability section on a route of a vehicle that is being driven;
a media player that plays a current content in the vehicle that is being driven and plays the alternative content when entering the predicted communication instability section or before entering the communication instability section; and
a media controller that selects the current content and the alternative content from the alternative content pool and provides the current content and the alternative content to the media player.

2. The autonomous driving system of claim 1, wherein the network sensitivity predictor predicts the communication instability section on the basis of the route of the vehicle or predicts the communication instability section on the basis of intensity of a signal received from another vehicle being driven ahead of the vehicle or a network.

3. The autonomous driving system of claim 1, wherein the alternative content collector creates the alternative content pool by selecting alternative contents suitable for user's long-term interests or profile.

4. The autonomous driving system of claim 3, further comprising an information provider that provides the alternative content suitable for one or more of short-term interest information received from the alternative content collector and context information indicating a situation in the vehicle to the alternative content collector,
wherein the alternative content collector updates the alternative content pool with the alternative contents provided from the information provider.

5. The autonomous driving system of claim 1, wherein the media control unit schedules a playback order of the alternative contents.

6. The autonomous driving system of claim 1, wherein the alternative content collector selects or adds the alternative contents on the basis of user's preference and interests learned on the basis of a content playback history and an application execution history of the user.

7. The autonomous driving system of claim 1, wherein the current content is one of a video/audio content and a broadcast signal that are received in real time through a streaming service.

8. The autonomous driving system of claim 7, wherein the media player is controlled by the media control unit to restart to play the current content when the vehicle that is being driven comes out of the predicted communication instability section and enters a communication stability section.

9. The autonomous driving system of claim 1, wherein the media control unit provides feedback data including user's reaction or action information to the alternative content played in the predicted communication instability section to the information provider when entering the communication stability section.

10. The autonomous driving system of claim 1, wherein the media control unit attempts communication reconnection by converting into a communication reconnection standby mode when a current poor communication state section is not the predicted communication instability section, and transmits alternative contents to the media player to play alternative contents in the alternative content pool randomly or sequentially in accordance with a priority order determined on the basis of learned user's preference and interests when media buffering continues for a predetermined time in the poor communication state section.

11. A media playback method comprising:
storing an alternative content pool into a media buffer of the vehicle by collecting alternative contents;
playing a current content in a vehicle that is being driven;
determining a predicted communication instability section on a route of the vehicle that is being driven; and
playing an alternative content selected from the alternative content pool when entering the predicted communication instability section or before entering the predicted communication instability section.

12. The media playback method of claim 11, further comprising predicting the communication instability section on the basis of the route of the vehicle or predicting the communication instability section on the basis of intensity of a signal received from another vehicle being driven ahead of the vehicle or a network.

13. The media playback method of claim 11, further comprising selecting and collecting the alternative contents on the basis of user's long-term interests or profile and short-term interests or context information indicating a situation in the vehicle.

14. The media playback method of claim 11, further comprising scheduling a playback order of the alternative contents.

15. The media playback method of claim 11, further comprising selecting or adding the alternative contents on the basis of user's preference and interests learned on the basis of a content playback history and an application execution history of the user.

16. The media playback method of claim 11, wherein the current content is one of a video/audio content and a broadcast signal that are received in real time through a streaming service.

17. The media playback method of claim 16, further comprising restarting to play the current content when the vehicle that is being driven comes out of the predicted communication instability section and enters a communication stability section.

18. The media playback method of claim 15, further comprising storing feedback data including user's reaction or action information to the alternative content played in the predicted communication instability section, or transmitting the feedback data to a network when entering the communication stability section.

19. The media playback method of claim 11, further comprising updating an alternative content pool stored in the media buffer in the communication stability section; and maintaining the alternative content pool stored in the media buffer in the predicted communication instability section.

20. The media playback method of claim 11, further comprising playing a content received from the another vehicle as the alternative content in the predicted communication instability section.
